(19) United States
(12) Patent Application Publication
(10) Pub. No.: US 2015/0223299 A1
(43) Pub. Date: Aug. 6, 2015

(54) CIRCUITS AND METHODS FOR CONTROLLING CURRENT IN A LIGHT EMITTING DIODE ARRAY

(71) Applicant: QUALCOMM Incorporated, San Diego, CA (US)

(72) Inventors: Troy Stockstad, Chandler, AZ (US); Bing Liu, San Diego, CA (US); Joseph D. Rutkowski, Chandler, AZ (US)

(73) Assignee: QUALCOMM Incorporated, San Diego, CA (US)

(21) Appl. No.: 14/171,472

(22) Filed: Feb. 3, 2014

(51) Int. Cl. H05B 33/08

(52) U.S. Cl. CPC H05B 33/0815; H05B 33/0845

(57) ABSTRACT

In one embodiment, a circuit comprises a current source to produce current to a light emitting diode array. An analog dimming circuit generates a continuous control signal to the current source to control the current in the light emitting diode array according to a range of control signal values when the control signal is above a threshold. Below the threshold, a digital modulation circuit generates an additional modulated digital signal to the current source to control the current in the light emitting diode array according to a range of modulation values when the continuous control signal is below the threshold. The continuous control signal produces current from the current source into the light emitting diode array above a first value. The combination of the continuous control signal and the modulated digital signal produces current in the light emitting diode array below the first value.

### BACKGROUND

The disclosure relates to circuits and methods for controlling current in a light emitting diode (LED) array.

Unless otherwise indicated herein, the approaches described in this section are not admitted to be prior art by inclusion in this section.

Various displays use light emitting diode (LED) arrays. A current is modulated over a range of voltages and applied to the array, for example, to change the brightness of the LED array. Analog dimming circuits are often used because of electromagnetic interference (EMI) concerns. However, at low duty cycles the low voltage in analog dimming circuits can cause flicker and other visual anomalies. Further, the current accuracy at these low duty cycles is poor.

### SUMMARY

The present disclosure describes a circuit for controlling current in a light emitting diode (LED) array. In one embodiment, a circuit comprises a current source to produce current to a light emitting diode array. An analog dimming circuit generates a continuous control signal to the current source to control the current in the light emitting diode array according to a range of control signal values when an input signal is above a threshold and to generate the continuous control signal according to a control signal value when the input signal is below the threshold. A digital modulation circuit generates a modulated digital signal to the current source to control the current in the light emitting diode array according to a range of modulation values when the continuous control signal is below the threshold. The continuous control signal produces current from the current source into the light emitting diode array above a first value. The modulated digital signal in combination with the continuous control signal produces current from the current source into the light emitting diode array below the first value.

In one embodiment, the analog dimming circuit comprises a first modulator generates the continuous control signal in response to the input signal.

In one embodiment, the digital modulation circuit comprises a normalization circuit to generate a normalized signal in response to the input signal. A second modulator is coupled to the normalization circuit to generate the modulated digital signal in response to the normalized signal.

In one embodiment, the normalization circuit comprises a summing block to add a bit to the input signal to generate an incremented signal. A multiplying block is coupled to the summing block to generate a normalized signal in response to the incremented signal.

In one embodiment, the normalization circuit comprises a shift left block to shift left the input signal to generate a normalized signal.

In one embodiment, the normalization circuit further comprises a summing block coupled to the shift left block to add a bit to the input signal.

In another embodiment, a circuit comprises a current source to produce current to a light emitting diode array. A switching circuit receives a first reference voltage and produces a second reference voltage that sets a current in the current source. The second reference voltage is based on a modulation value of a first modulation signal to the switching circuit. A multiplexer receives a threshold and a dimming control signal. A comparison circuit receives the threshold and the dimming control signal. The comparison circuit causes the multiplexer to output the dimming control signal when the dimming control signal is greater than the threshold. A first modulator is coupled to an output of the comparison circuit to receive one of the threshold and the dimming control signal and produce the first modulated signal. The first modulated signal has a modulation value corresponding to the greater of the threshold and the dimming control signal from the multiplexer. A second modulator receives a signal corresponding to the dimming control signal, and in accordance therewith, produces a second modulation signal having a range of modulation values corresponding to dimming control signal values below the threshold. The switching circuit generates a continuous range of reference voltages to adjust the current in the light emitting diode array when the dimming control signal is above the threshold and clamps the value at or below the threshold. The second modulation signal turns the current source on and off across a range of modulations values when the dimming control signal is below the threshold.

In one embodiment, the circuit further comprises a shift circuit configured between the dimmer control signal and the second modulator to normalize the dimmer control signal, wherein the dimmer control signal is equal to powers of two (2).

In one embodiment, the circuit further comprises a third modulator coupled between the dimmer control signal and the multiplexer to generate a first modulated signal in response to the dimmer control signal. The second modulator generates the continuous control signal in response to the first modulated signal.

In one embodiment, the circuit further comprises a third modulator and an accumulate and dump circuit coupled between the dimmer control signal and the multiplexer. The third modulator generates a first modulated signal in response to the dimmer control signal. The accumulate and dump circuit is coupled to the third modulator to generate an accumulated modulated signal in response to the first modulated signal. A second modulator is coupled to the accumulate and dump circuit to generate the continuous control signal in response to the accumulated modulated signal.

In one embodiment, the circuit further comprises a normalization circuit coupled between the dimming control signal and the second modulator to provide the signal corresponding to the dimming control signal to the second modulator.

In one embodiment, the normalization circuit comprises a summing block to add a bit to the dimming control signal to generate an incremented signal. A multiplying block is coupled to the summing block to generate the signal corresponding to the dimming control signal in response to the incremented signal.

In one embodiment, the normalization circuit comprises a shift left block to shift left the dimming control signal to the signal corresponding to the dimming control signal in response to the dimming control signal.

In yet another embodiment, a method comprises generating a continuous control signal to control current in a light emitting diode array according to a range of control signal values when an input signal is above a threshold and to generate the continuous control signal according to a control signal value when the input signal is below the threshold; and additionally generating a modulated digital signal to control the current in the light emitting diode array according to a range of modulation values when the continuous control signal is below the threshold. The continuous control signal produces current in the light emitting diode array above a first value. At control signal values at or below the threshold, the continuous control signal is unchanged from its behavior at the threshold level. The modulated digital signal further modulates current in the light emitting diode array below the first value, by turning the current source on and off, depending upon the state of the digital control signal.

In one embodiment, generating the modulated digital signal includes adding a bit to the input signal to generate an incremented signal; and multiplying the incremented signal by a reciprocal of the threshold to normalize the incremented signal. In one embodiment, generating the modulated digital signal further includes pulse width modulating the incremented signal to generate modulated digital signal.

In one embodiment, generating the modulated digital signal includes shifting the input signal to normalize the continuous control signal, wherein the continuous control signal is equal to powers of two. In one embodiment, generating the modulated digital signal further includes pulse width modulating the incremented signal to generate modulated digital signal.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, make apparent to those of skill in the art how embodiments in accordance with the present disclosure may be practiced. In the accompanying drawings:

FIG. 1 illustrates a block diagram of a light emitting diode array circuit according to an embodiment.

FIG. 2 illustrates a block diagram of a mixed mode dimming circuit according to an embodiment.

FIG. 3 illustrates a block diagram of a mixed mode dimming circuit according to another embodiment.

FIG. 4 illustrates a block diagram of a mixed mode dimming circuit according to yet another embodiment.

FIG. 5 illustrates a simplified diagram illustrating a process flow for controlling current in a light emitting diode array according to an embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

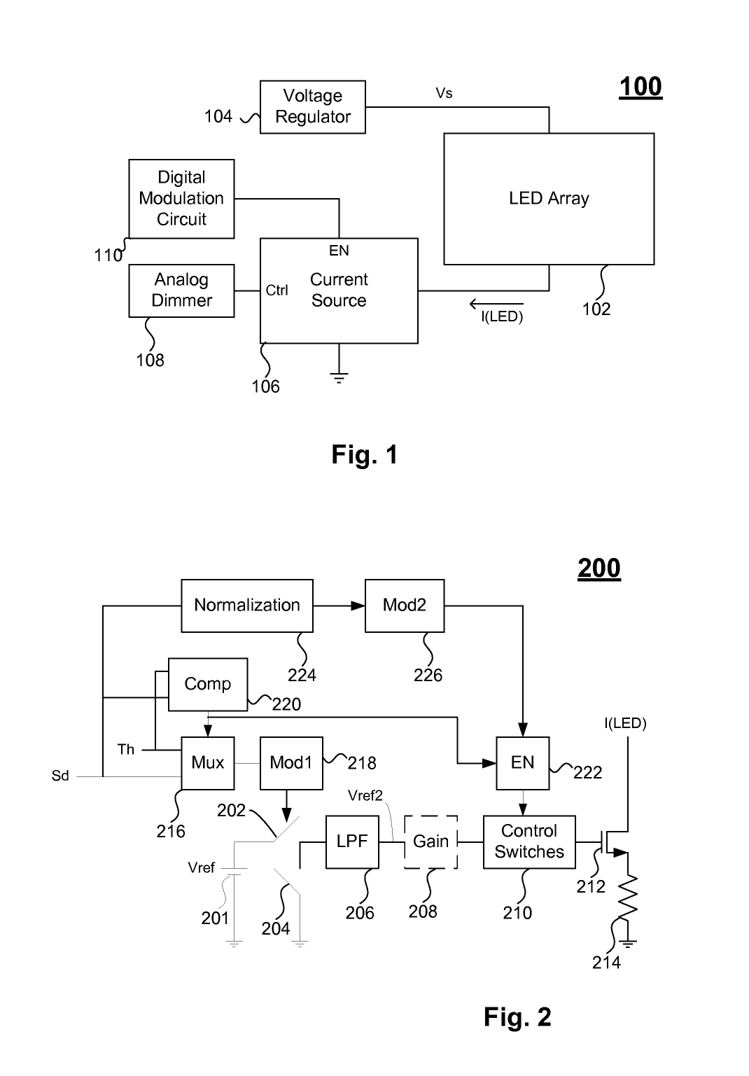

FIG. 1 illustrates a light emitting diode (LED) array circuit 100 according to an embodiment. LED array circuit 100 comprises a light emitting diode (LED) array 102, a voltage regulator 104, a current source 106, an analog dimming circuit 108, and a digital modulation circuit 110. In various embodiments, LED array 102 can be a White LED array. In one embodiment, the modulation of the current for white LED bias is for backlight of a display panel. In some embodiments, LED circuit 100 can be used in smart phones, tablets, and display panels.

Light Emitting Diode (LED) array 102 can be driven using a supply voltage Vs from voltage regulator 104 and a LED current I(LED) from current source 106. Current source 106 produces the LED current I(LED) in LED array 102 that may be used to set brightness in a backlight of a display. In some embodiments, current source 106 changes the current to change the brightness based on a display application (e.g., based on detecting ambient light conditions).

LED array circuit 100 includes circuits for providing both an analog dimming technique and a digital dimming technique. The two techniques are used in mixed mode dimming that includes a digital dimming mode. The analog diming technique is used in an analog dimming mode. Analog dimming circuit 108 controls the LED current I(LED) using the analog dimming technique above a threshold. The analog dimming can be modulation of a voltage reference that is applied to current source 106 when duty cycles of modulation are above the threshold. Below such threshold, LED array circuit 100 uses the mixed mode dimming. Analog dimming circuit 108 controls the LED current I(LED) based on a current at the threshold. Digital modulation circuit 110 uses the digital dimming technique to further control the LED current I(LED). The digital dimming can be digital modulation of turning on and off current source 106 at duty cycles between the threshold and a zero duty cycle. In various embodiments, the threshold is programmable. In various embodiments, at the threshold, LED array circuit 100 can operate in analog dimming mode. In other embodiments, at the threshold, LED array circuit 100 can operate in mixed mode dimming.

Analog dimming circuit 108 generates a continuous control signal to current source 106 to control the LED current I(LED) in LED array 102 according to a range of control signal values when the control signal is above the threshold. For example, analog dimming circuit 108 may produce a voltage that can range from 2 mV to 0.2 V. The voltage may vary continuously across this range, and produce a corresponding range of current values in the LED array 102. When the control signal value is below the threshold, analog dimming circuit 108 generates the continuous control signal based on the threshold value. Accordingly, digital modulation circuit 110 generates a modulated digital signal to current source 106 to further control the LED current I(LED) in LED array 102 according to a range of modulation values below the threshold. For example, when the control signal value drops below the threshold, analog dimming circuit 108 continues to generate a continuous control signal at the threshold value (e.g., 2 mV), while digital modulation circuit 110 may modulate the LED current I(LED) in LED array 102 directly (e.g., by turning current source 106 on and off). The modulations values (e.g., duty cycle) of digital modulation circuit 110 may be reduced to further reduce the LED current I(LED).

Analog dimming circuit 108 provides a constant current modulated reference to current source 106. Digital modulation circuit 110 turns current source 106 on and off. Digital dimming can be used to reduce flicker of LED array 102. This is accomplished by maintaining the level of the analog continuous control signal at or above the threshold value (e.g., 2 mV), even for effective current source modulation values very near zero. In various embodiments, the voltage reference is driven to the programmable threshold level while the digital dimming further reduces the current of current source 106.

FIG. 2 illustrates a block diagram of a mixed mode dimming circuit 200 according to an embodiment. Mixed mode dimming circuit 200 comprises a reference voltage source 201, a plurality of switches 202 and 204, a low pass filter (LPF) 206, an optional gain stage 208, control switches 210, an n-type metal-oxide-semiconductor (NMOS) transistor 212, a resistor 214, a multiplexer 216, a modulator 218, a comparator 220, an enable circuit 222, a normalization circuit 224, and a modulator 226.

Reference voltage source 201 provides a first reference voltage Vref to a switching circuit formed of switches 202 and 204 and low pass filter 206 to produce a second reference voltage Vref2. Modulation circuit 218 drives switches 202 and 204. The second reference voltage Vref2 is a function of the duty cycle of the output of modulation circuit 218. The second reference voltage Vref2 is coupled through gain stage 208 and control switches 210 to the gate of a NMOS transistor 212 so that the voltage across resistor 214 is equal to the second reference voltage Vref2 multiplied by the voltage gain of optional gain stage 208 to set the value of the LED current I(LED). The NMOS transistor 212 and the resistor 214 form a current source for generating the LED current I(LED). Accordingly, the switching circuit formed of switches 202 and 204 and filter 206 generates a continuous range of reference voltages to adjust the current I(LED) in the LED array 102.

The second reference voltage Vref2 acts as a control signal to set the LED current I(LED). The second reference voltage Vref2 is set by the dimmer control signal Sd. In this example, the dimmer control signal Sd is compared to a threshold Th in comparison circuit 220. If the dimmer control signal Sd is greater than the threshold Th, then comparison circuit 220 causes multiplexer 216 to provide the dimmer control signal Sd to the input of modulator 218. Accordingly, when the dimmer control signal Sd is greater than the threshold Th, the dimmer control signal Sd sets the duty cycle of modulator 218, and therefore, the dimmer control signal Sd controls the value of the second reference voltage Vref2 and the LED current I(LED). Thus, the dimmer control signal Sd may be increased and decreased to control corresponding increases and decreases in the LED current I(LED). However, when the dimmer control signal Sd is less than the threshold Th, comparison circuit 220 causes multiplexer 216 to provide the threshold Th to the input of modulator 218. Accordingly, when the dimmer control signal Sd is less than the threshold Th, the threshold Th sets a minimum duty cycle on modulator 218, and therefore, the threshold Th sets a minimum value of the second reference voltage Vref2 and the LED current I(LED).

The dimmer control signal Sd is also coupled to modulator 226 through normalization circuit 224. When the dimmer control signal Sd is less than the threshold Th, comparison circuit 220 causes enable circuit 222 (e.g., a logic circuit) to couple an output of modulator 226 to control switches 210 to modulate the gate of NMOS transistor 212, and thereby modulate the LED current I(LED). When the dimmer control signal Sd is less than the threshold Th, modulator 226 may directly modulate NMOS transistor 212 by turning the current on and off according to the duty cycle of modulator 226. In this example, normalization circuit 224 scales the dimmer control signal Sd so that when the dimmer control signal Sd equals the threshold Th (at the transition point), modulator 226 is at full scale (e.g., control switches 210 are just starting to become active). In one embodiment, the dimmer control signal Sd may be constrained to powers of two (2), and normalization circuit 224 may be a shift circuit, for example, to normalize dimmer control signal Sd. As the dimmer control signal Sd decreases below the threshold Th, the duty cycle of modulator 226 increases the time that control switches 210 periodically turn off NMOS transistor 212. Therefore, below the threshold Th, the dimmer control signal Sd modulates the average current I(LED) by the product of the modulation provided by modulator 218 and modulator 226.

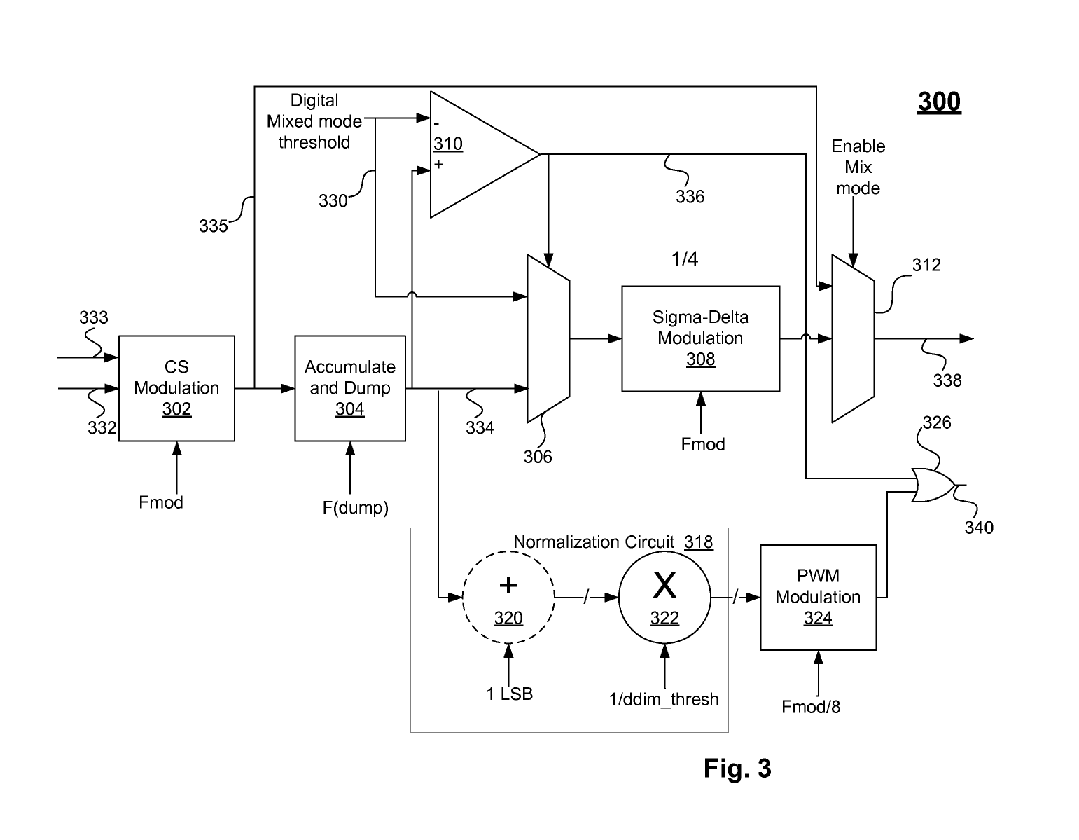

FIG. 3 illustrates a block diagram of a mixed mode dimming circuit 300 according to an embodiment. Mixed mode dimming circuit 300 comprises a current sink modulator 302, an accumulate and dump block 304, a multiplexer 306, a sigma-delta modulator 308, a comparator 310, a multiplexer 312, a normalization circuit 318, a pulse width modulator 324, and an OR gate 326. Modulator 302, accumulate and dump block 304, and sigma-delta modulator 308 provide the current control signals during the analog dimming mode. Normalization circuit 318, pulse width modulator 324, and OR gate 326 provide the current control signals during the digital dimming mode. Comparator 310 provides a control signal to switch between the analog dimming mode and the mixed mode dimming Normalization circuit 318 comprises an optional summing block 320 and a multiplying block 322.

Modulator 302 modulates a frequency signal (Fmod) with a reference duty control signal 332 and a content adaptive brightness control (CABC) signal 333 using, for example, sigma-delta modulation to generate a modulated signal 335. In this example, a 12 bit reference duty control signal 332 is modulated to a 1 bit signal. Although mixed mode dimming circuit 300 is described as including current sink modulator 302 and accumulate and dump block 304, other implementations can be used for multiplying the CABC signal 333 with the duty control signal 332. For example, a multiplier can be used instead of current sink modulator 302 and accumulate and dump block 304. Modulator 302 provides the modulated signal 335 to accumulate and dump block 304 and multiplexer 312. Accumulate and dump block 304 integrates the modulated signal from modulator 302 at a dump frequency F(dump), and provides an accumulated modulated signal 334 to multiplexer 306 and normalization circuit 318. In this example, the dump frequency can be the modulation frequency Fmod divided by 2¹². In this example, the accumulated modulated signal 334 is a 12 bit signal.

A digital mixed mode threshold signal 330 is provided to an input of multiplexer 306 and comparator 310. In some embodiments, the digital mixed mode threshold signal 330 is a programmable threshold.

Comparator 310 generates a mixed mode selection signal 336 to select between mixed mode dimming and analog dimming mode in response to the accumulated modulated signal 334 (e.g., duty cycle) being below or above, respectively, the digital mixed mode threshold signal 330. In this example, the mixed mode selection signal 336 is low when the accumulated modulated signal 334 is less than the mixed mode threshold signal 330. The mixed mode selection signal 336 is provided to multiplexer 306 and OR gate 326. Multiplexer 306 provides the digital mixed mode threshold signal 330 or the accumulated modulated signal 334 output from accumulate and dump block 304 in response to the mixed mode selection signal 336. Multiplexer 306 functions as a clamp on the analog duty cycle.

When the mixed mode selection signal 336 is high (e.g., the accumulated modulated signal 334 is greater than the digital mixed mode threshold signal 330), the circuit 300 operates in the analog dimming mode. The output of multiplexer 306 is modulated by sigma-delta modulator 308 at the modulation frequency Fmod, and the modulated signal is provided to multiplexer 312. Responsive to an enable mixed mode signal, multiplexer 312 provides the modulated signal 335 from modulator 302 or the output of sigma-delta modulator 308 to the control switches 206 and 204. When selected by enable mixed mode signal, multiplexer 312 provides modulated signal 335 as continuous control signal 338 as the output of multiplexer 312 to modulate the LED current I(LED) in a mode that bypasses the mixed dimming mode.

The output 340 of OR gate 326 is high, and the digital current signal is high while accumulate and dump 304 is greater than the mixed mode dimming threshold 330.

When the mixed mode selection signal 336 is low (e.g., the accumulated modulated signal 334 is less than the digital mixed mode threshold signal 330), the circuit 300 operates in the mixed mode dimming mode.

Summing block 320 adds one least significant bit (LSB) to the accumulated modulated signal 334 from accumulate and dump block 304 and provides the incremented signal to multiplying block 322. In some embodiments, mixed mode dimming circuit 300 does not include summing block 320. Multiplying block 322 multiplies the incremented signal by the reciprocal of the digital mixed mode threshold 330 to generate a normalized signal. In this example, the normalized signal has 9 bits. Pulse width modulator 324 pulse width modulates the normalized signal using the modulation frequency Fmod/8, and provides the pulse width modulated signal to the OR gate 326. OR gate 326 provides the pulse width modulated signal to enable circuit 222 when mixed mode selection signal 336 is low (the digital dimming mode is enabled). Otherwise, OR gate 326 provides mixed mode selection signal 336 to enable circuit 222 when mixed mode selection signal 336 is high (the analog dimming mode is enabled).

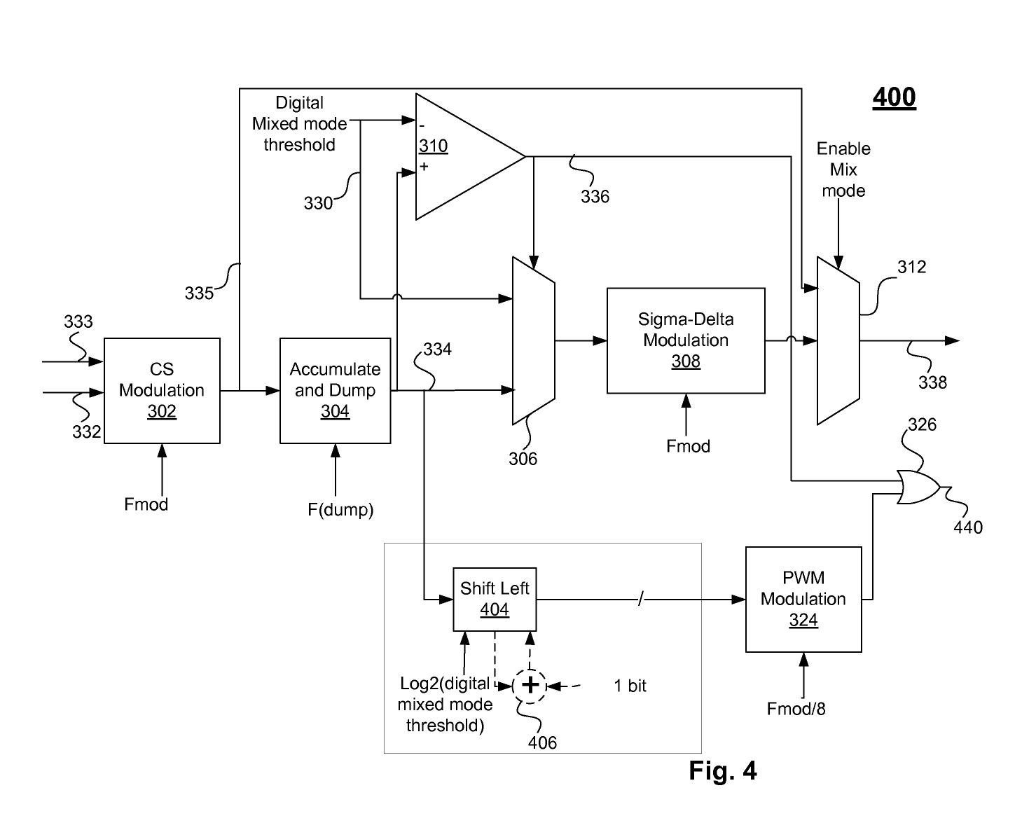

FIG. 4 illustrates a block diagram of a mixed mode dimming circuit 400 according to an embodiment. Mixed mode dimming circuit 400 is similar to mixed mode dimming circuit 300 and further comprises a shift block 404 and an optional summing block 406 instead of a summing block 320 and a multiplier 322. As an example, the dump frequency can be the modulation frequency Fmod divided by 2¹².

In various embodiments, mixed mode dimming circuit 400 includes a look up table (LUT) coupled between digital mixed mode threshold 330 and multiplexer 306 to provide a reduced digital mixed mode threshold 330 (e.g., subtraction of a bit from the threshold) when the accumulated modulated signal 334 is less than the digital mixed mode threshold signal 330.

Shift block 404 shifts the accumulated modulated signal 334 to the left by, for example, one bit, in response to log base 2 of the digital mixed mode threshold 330 where the threshold is a power of two (2).

In some embodiments, an optional summing block 406 adds one bit to the shifted signal of shift block 404. In this example, the output of the shift block 404 is 9 bits.

In various embodiments, digital mixed mode threshold 330 can be a ½^{N} duty cycle.

In various embodiments, the modulation frequency Fmod can be 1.2 MHz, 2.4 MHz, 4.8 MHz or 19.2 MHz.

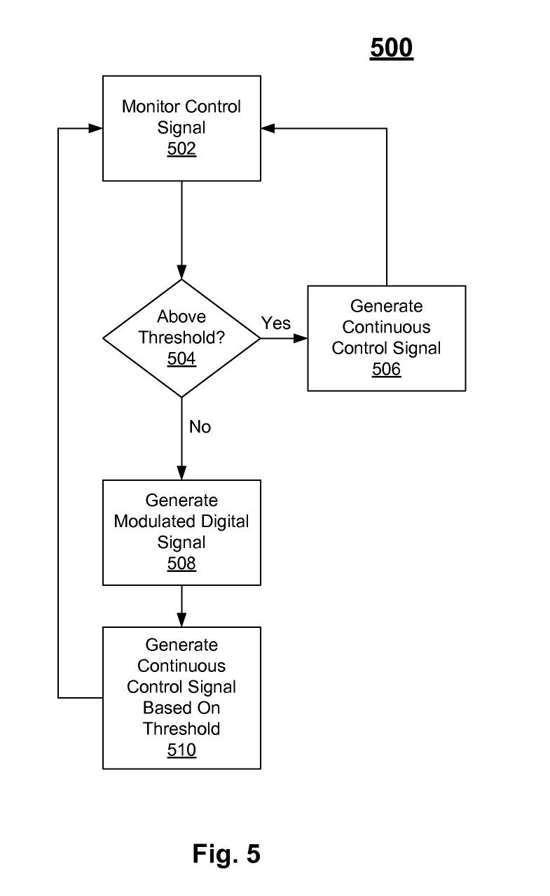

FIG. 5 illustrates a simplified diagram illustrating a process flow for controlling current in LED array 102 according to an embodiment. At 502, a continuous control signal (e.g., accumulated modulated signal 334) is monitored. If, at 504, the continuous control signal is above the threshold (e.g., digital mixed mode threshold 330), at 506, a continuous control signal 338 is generated to control LED current I(LED) in LED array 102 according to a range of control signal values (e.g., reference duty control signal 332). Otherwise, if, at 504, the continuous control signal is not above the threshold, at 508, a modulated digital signal 340 is also generated to control LED current I(LED) in LED array 102 according to a range of modulation values. At 510, a continuous control signal 338 is generated to control LED current I(LED) in LED array 102 according to the threshold. The continuous control signal 338 produces current in LED array 102 above a value (e.g., a current level that corresponds to a duty cycle based on the threshold), and the modulated digital signal 340 produces current in the light emitting diode array 102 below the value, in combination with the continuous control signal 338, which is operating at the threshold value.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A circuit comprising:
a current source to produce current to a light emitting diode array;
an analog dimming circuit to generate a continuous control signal to the current source to control the current in the light emitting diode array according to a range of control signal values when an input signal is above a threshold and to generate the continuous control signal according to a control signal value when the input signal is below the threshold; and
a digital modulation circuit to generate a modulated digital signal to the current source to control the current in the light emitting diode array according to a range of modulation values when the continuous control signal is below the threshold;
wherein the continuous control signal produces current from the current source into the light emitting diode array above a first value, and the modulated digital signal in combination with the continuous control signal produces current from the current source into the light emitting diode array below the first value.

2. The circuit of claim 1 wherein the analog dimming circuit comprises:
a first modulator to generate the continuous control signal in response to the input signal.

3. The circuit of claim 2 wherein the digital modulation circuit comprises:
a normalization circuit to generate a normalized signal in response to the input signal; and
a second modulator coupled to the normalization circuit to generate the modulated digital signal in response to the normalized signal.

4. The circuit of claim 3 wherein the normalization circuit comprises:
a summing block to add a bit to the input signal to generate an incremented signal; and
a multiplying block coupled to the summing block to generate a normalized signal in response to the incremented signal.

5. The circuit of claim 3 wherein the normalization circuit comprises:
a shift left block to shift left the input signal to generate a normalized signal.

6. The circuit of claim 5 wherein the normalization circuit further comprises:
a summing block coupled to the shift left block to add a bit to the input signal.

7. The circuit of claim 1 wherein the digital modulation circuit comprises:
a normalization circuit to generate a normalized signal in response to the input signal; and
a first modulator coupled to the normalization circuit to generate the modulated digital signal in response to the normalized signal.

8. The circuit of claim 7 wherein the normalization circuit comprises:
a summing block to add a bit to the input signal to generate an incremented signal; and
a multiplying block coupled to the summing block to generate a normalized signal in response to the incremented signal.

9. A circuit comprising:
a current source to produce current to a light emitting diode array;
a switching circuit to receive a first reference voltage and produce a second reference voltage that sets a current in the current source, wherein the second reference voltage is based on a modulation value of a first modulation signal to the switching circuit;
a multiplexer to receive a threshold and a dimming control signal;
a comparison circuit to receive the threshold and the dimming control signal, the comparison circuit causing the multiplexer to output the dimming control signal when the dimming control signal is greater than the threshold;
a first modulator coupled to an output of the comparison circuit to receive one of the threshold and the dimming control signal and produce the first modulated signal, the first modulated signal having a modulation value corresponding to the greater of the threshold and the dimming control signal from the multiplexer; and
a second modulator to receive a signal corresponding to the dimming control signal, and in accordance therewith, produce a second modulation signal having a range of modulation values corresponding to dimming control signal values below the threshold;
wherein the switching circuit generates a continuous range of reference voltages to adjust the current in the light emitting diode array when the dimming control signal is above the threshold, and clamps the value at or below the threshold, and
wherein the second modulation signal turns the current source on and off across a range of modulations values when the dimming control signal is below the threshold.

10. The circuit of claim 9 further comprising a shift circuit configured between the dimmer control signal and the second modulator to normalize the dimmer control signal, wherein the dimmer control signal is equal to powers of two (2).

11. The circuit of claim 9 further comprising:
a third modulator coupled between the dimmer control signal and the multiplexer to generate a first modulated signal in response to the dimmer control signal,
wherein the second modulator generates the continuous control signal in response to the first modulated signal.

12. The circuit of claim 9 further comprising:
a third modulator and an accumulate and dump circuit coupled between the dimmer control signal and the multiplexer,
wherein the third modulator generates a first modulated signal in response to the dimmer control signal,
wherein the accumulate and dump circuit is coupled to the third modulator to generate an accumulated modulated signal in response to the first modulated signal;
a second modulator coupled to the accumulate and dump circuit to generate the continuous control signal in response to the accumulated modulated signal.

13. The circuit of claim 9 further comprising a normalization circuit coupled between the dimming control signal and the second modulator to provide the signal corresponding to the dimming control signal to the second modulator.

14. The circuit of claim 13 wherein the normalization circuit comprises:
a summing block to add a bit to the dimming control signal to generate an incremented signal; and
a multiplying block coupled to the summing block to generate the signal corresponding to the dimming control signal in response to the incremented signal.

15. The circuit of claim 13 wherein the normalization circuit comprises:
a shift left block to shift left the dimming control signal to the signal corresponding to the dimming control signal in response to the dimming control signal.

16. A method comprising:
generating a continuous control signal to control current in a light emitting diode array according to a range of control signal values when an input signal is above a threshold and to generate the continuous control signal according to a control signal value when the input signal is below the threshold; and
additionally generating a modulated digital signal to control the current in the light emitting diode array according to a range of modulation values when the continuous control signal is below the threshold,
wherein the continuous control signal controls current in the light emitting diode array above a first value, and the combination of the continuous control signal and the modulated digital signal produces current in the light emitting diode array below the first value.

17. The method of claim 16 wherein generating the modulated digital signal includes:
adding a bit to the input signal to generate an incremented signal; and multiplying the incremented signal by a reciprocal of the threshold to normalize the incremented signal.

18. The method of claim 17 wherein generating the modulated digital signal includes:
pulse width modulating the incremented signal to generate modulated digital signal.

19. The method of claim 16 wherein generating the modulated digital signal includes:
shifting the input signal to normalize the continuous control signal, wherein the continuous control signal is equal to powers of two.

20. The method of claim 19 wherein generating the modulated digital signal includes:
pulse width modulating the incremented signal to generate modulated digital signal.
